(19) United States
(12) Patent Application Publication
(10) Pub. No.: US 2020/0258385 A1
(43) Pub. Date: Aug. 13, 2020

(54) ADVANCED DETECTION OF PARKING SPOT FOR VEHICLE

(71) Applicant: Byton North America Corporation, Santa Clara, CA (US)

(72) Inventor: Pankaj Mahajan, West Bloomfield, MI (US)

(21) Appl. No.: 16/272,800

(22) Filed: Feb. 11, 2019

(51) Int. Cl. G08G 1/14; G06K 9/00; G06T 7/60; G06T 7/50; G06T 7/70; G01S 13/89; G01S 17/89

(52) U.S. Cl. CPC G08G 1/143; G06K 9/00812; G06T 7/60; G06T 7/50; G06T 2207/10044; G01S 13/89; G01S 17/89; G06T 2207/10028; G06T 7/70

(57) ABSTRACT

Systems and methods to provide advanced detection of parking spot for a vehicle are described. Signals reflected from one or more objects are received using at least one of a plurality of sensors coupled to a vehicle. One or more images are generated based on the reflected signals. One or more empty spaces as candidates for one or more available parking spots for the vehicle are determined based on the one or more images. A map including the one or more available parking spots for the vehicle is generated.

### FIELD

Embodiments of the invention relate to vehicles e.g., automobiles, buses, trucks, or other vehicles. More particularly, embodiments of the invention relate to advanced methods and systems to detect an empty parking spot for a vehicle.

### BACKGROUND

Currently, radars and lasers are used to detect objects. Generally, radar or laser incident waves reflect off the object and return to the receiver, giving information about the object's. Currently, parking garages are experimenting with different approaches to detect empty spaces so that entering cars can more easily detect them. Currently, a vehicle cannot automatically detect an empty parking spot. BMW has demonstrated an automated valet capability for its cars. There are also demos of automated valet machines that can be used in a parking garage.

Typically, detecting the empty parking spot requires a human eye. Finding an empty parking spot can be difficult in a large crowded parking structure. A driver typically may have to do multiple passes through lanes in structures to find an empty parking spot. Both time and fuel (or battery charge for an electric vehicle) are typically wasted in unsuccessful attempts to find a parking spot in a crowded parking structure. In addition, for a vehicle with an internal combustion engine, excess noxious emissions are generated in searching for a parking spot in a crowded parking structure—similar issues apply with respect to attempting to park on crowded streets.

### SUMMARY

Systems and methods to provide advanced detection of parking spot for a vehicle are described. The systems and methods use data from sensors on a vehicle to detect an empty parking spot for the vehicle.

For one embodiment, a driving system comprises a plurality of sensors. A processor is coupled to the plurality of sensors to receive electromagnetic waves signals reflected from one or more objects. A processor is coupled to the one or more cameras. The processor is configured to generate one or more images based on the reflected electromagnetic waves signals. The processor is configured to determine one or more empty spaces as candidates for one or more available parking spots for the vehicle based on the one or more images. For one embodiment, determining an empty space as a candidate for an available parking spot is based on one or more characteristics of the empty parking spot, as described in further detail below. The processor is configured to generate a map including the one or more available parking spots for the vehicle.

For one embodiment, electromagnetic waves signals reflected from one or more objects are received using at least one of a plurality of sensors coupled to a vehicle. One or more images are generated based on the reflected signals. One or more empty spaces as candidates for one or more available parking spots for the vehicle are determined based on the one or more images. A map including the one or more available parking spots for the vehicle is generated.

For one embodiment, a non-transitory machine-readable medium stores executable computer program instructions which when executed by one or more data processing systems cause the one or more data processing systems to perform operations that comprise receiving first electromagnetic waves signals reflected from one or more first objects using at least one of a plurality of sensors coupled to a vehicle; generating one or more images based on the first electromagnetic waves signals; determining one or more empty spaces as candidates for one or more available parking spots for the vehicle based on the one or more images; and generating a map including the one or more available parking spots for the vehicle.

Other systems, methods, and machine-readable mediums to recognize parking for an automobile are also described.

### BRIEF DESCRIPTION OF THE DRAWINGS

The appended drawings illustrate examples and are, therefore, exemplary embodiments and not considered to be limiting in scope.

FIG. 1 is a top view 100 of a vehicle 110 that automatically detects an empty parking spot for a vehicle according to an embodiment of the invention.

FIG. 2 is a block diagram of a data processing system 200 of a vehicle according to an embodiment of the invention.

FIG. 3 is a flowchart of a method 300 to detect am empty parking spot for a vehicle according to one embodiment of the invention.

FIG. 4 is a flowchart of a method 400 to detect an empty parking spot for a vehicle according to one embodiment of the invention.

FIG. 5 shows an example of a data structure 500 that includes a priority list of one or more available parking spots according to one embodiment.

FIG. 6 is a view 600 of a parking garage 610 for vehicles according to one embodiment of the invention.

FIG. 7 is a view 700 of a map 701 including locations of available parking spots according to one embodiment of the invention.

FIG. 8 is a view 800 of a street parking 811 according to one embodiment of the invention.

FIG. 9 shows an example of an image 900 that is generated based on the combined radar sensor data and LiDAR sensor data according to one embodiment.

FIG. 10 is an example of a driving system 1000 to perform one or more methods described herein.

### DETAILED DESCRIPTION

Systems and methods to provide advanced detection of parking spot for a vehicle are described. The systems and methods use data from sensors on a vehicle to detect an empty parking spot for the vehicle. The disclosed techniques to advantageously detect an empty parking spot for a vehicle dynamically (i.e., on the fly) are performed automatically without human intervention.

For one embodiment, electromagnetic waves signals reflected from one or more objects are received using at least one of a plurality of sensors coupled to a vehicle. One or more images are generated based on the reflected electromagnetic waves signals. One or more empty spaces as candidates for one or more available parking spots for the vehicle are determined based on the one or more images. A map including the one or more available parking spots for the vehicle is generated. Although the following examples and embodiments address advance detection of an empty parking spot for a vehicle, such techniques can be applied to any type of environment that needs an empty space detection.

Various embodiments and aspects will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments.

Reference in the specification to “one embodiment” or “an embodiment” means that a particular feature, structure, or characteristic described in conjunction with the embodiment can be included in at least one embodiment. The appearances of the phrases “in one embodiment” or “for one embodiment” in various places in the specification do not necessarily all refer to the same embodiment. The processes depicted in the figures that follow are performed by processing logic that comprises hardware (e.g. circuitry, dedicated logic, etc.), software, or a combination of both. Although the processes are described below in terms of some sequential operations, it should be appreciated that some of the operations described may be performed in a different order. Moreover, some operations may be performed in parallel rather than sequentially.

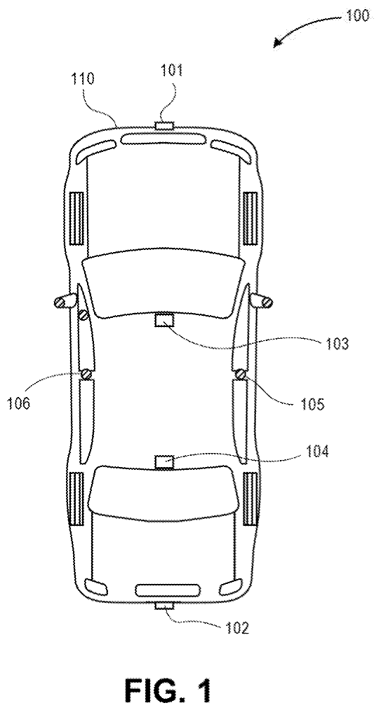

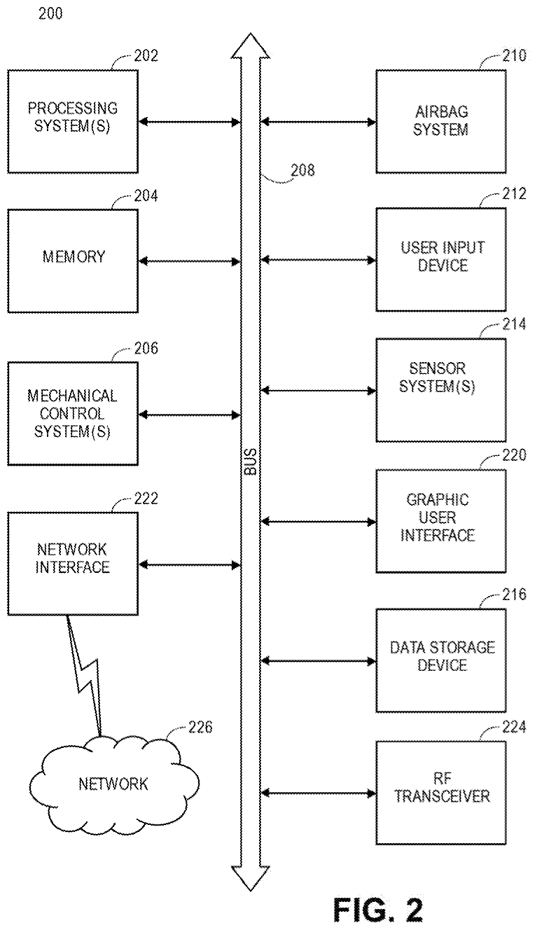

FIG. 1 is a top view 100 of a vehicle 110 that automatically detects an empty parking spot for a vehicle according to an embodiment of the invention. As shown in FIG. 1, vehicle 110 includes a set of sensors 101, 102, 103, 104, 105 and 106 mounted on and at different locations of the vehicle that can be used to detect an empty parking spot, as described in further detail below with respect to FIGS. 2-9. For one embodiment, vehicle 110 is a car, a sport-utility vehicle (SUV), a truck, a bus, or any other machine that transports people, cargo, or a combination thereof. For one embodiment, vehicle 110 is an autonomous driving (AD) vehicle. The vehicle can be an electric vehicle or a vehicle with an internal combustion engine. For other embodiments, the vehicle can be a train, a boat, an aircraft, or a spacecraft.

For one embodiment, the set of sensors 101, 102, 103, 104, 105 and 106 includes one or more LiDAR sensors, one or more radar sensors, one or more ultrasonic sensors, one or more cameras, one or more global positioning system (GPS) sensors, additional sensors, or any combination thereof.

As shown in FIG. 1, the vehicle 110 includes a sensor 101 on the front bumper of the vehicle. For one embodiment, vehicle 110 includes a sensor 102 on the rear bumper of the vehicle. For one embodiment, vehicle 110 includes a sensor 103 on a top of the vehicle. For one embodiment, at least one of the sensors 101, 102 and 103 includes one or more LiDAR sensors, one or more radar sensors, or a combination of one or more LiDAR sensors and one or more radar sensors.

For one embodiment, the LiDAR sensor includes a transmitter to transmit a laser light to illuminate a target object, and a processor coupled to a receiver to receive the laser light that is reflected from the target object. The processor of the LiDAR sensor is configured to measure differences in laser light return times and wavelengths and estimate a distance to the target object, to generate a digital (e.g., 2D, 3D) representations of the target object to perform methods described below. For one embodiment, the laser light of the LiDAR sensor is an infrared light. For one embodiment, the laser light wavelength of the LiDAR sensor is in an approximate range from 110 nanometers (nm) to about 140 nanometers. For one embodiment, the laser light wavelength of the LiDAR sensor is about 130 nm. For one embodiment, the viewing angle of the LiDAR sensor is about 120 degrees.

For one embodiment, a radar sensor includes a transmitter coupled to a transmitting antenna to transmit radar waves to a target object, a processor coupled to the transmitter, and a receiver coupled to the processor and a receiving antenna to receive the radar waves that are reflected from the target object to obtain information about the location, size and speed of the object to perform methods described below. For one embodiment, the radar wave wavelength is in an approximate range from about 1 millimeter (mm) to about 10,000 kilometers (km). For one embodiment, the radar wave wavelength is in an approximate range from about 1 mm to about 1 meter (m). For one embodiment, the viewing angle of radar sensor is greater than the viewing angle of LiDAR sensor.

For one embodiment, sensor 105 includes a top camera at one side of the vehicle 110 and sensor 106 includes a top camera at an opposite side of the vehicle 110. The one or more cameras can include any type of commercially available camera, e.g., a visible spectrum camera, a stereo camera, a red, green, blue (RGB) camera, an infrared camera, or any other camera to capture images.

For one embodiment, sensor 104 includes one or more GPS sensors, one or more ultrasonic sensors, one or more accelerometers, or any combination thereof. Although the set of sensors 101, 102, 103, 104, 105, and 106 are depicted at certain positions on the vehicle 100, the set of sensors 101, 102, 103, 104, 105, and 106 can be placed at any other positions on vehicle 100 based on a design.

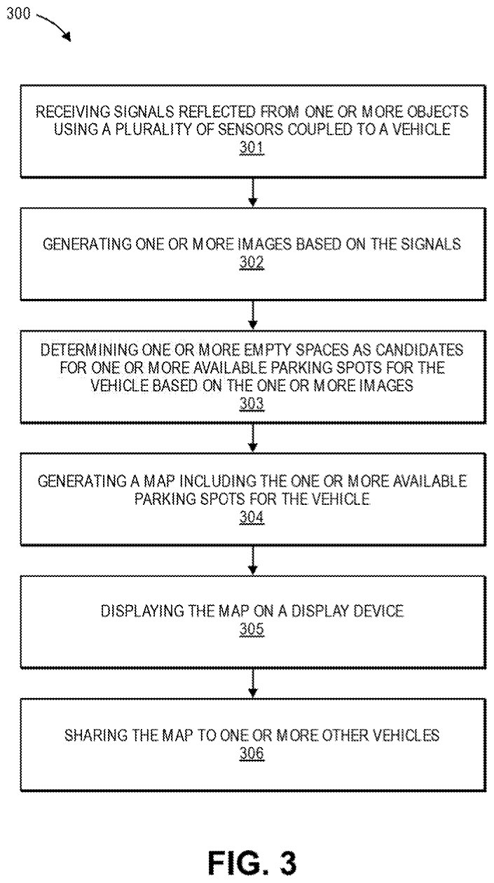

FIG. 2 is a block diagram of a data processing system 200 of a vehicle according to an embodiment of the invention. For one embodiment, the vehicle is represented by vehicle 110. For one embodiment, the vehicle is coupled to data processing system 200. For one embodiment, vehicle 110 includes at least a portion of data processing system 200. The data processing system 200 includes a set of instructions to cause the vehicle to perform any one or more of the features and functions to detect an empty parking spot, as described in further detail with respect to FIGS. 3-9. In one example, the vehicle may communicate via a network 226 to other machines or vehicles. For one embodiment, network 226 is a local area network (LAN), the Internet, or other communication network. For one embodiment, network 226 includes a wireless network. The vehicle can transmit communications (e.g., across the Internet, any wireless communication) to indicate detection of an empty parking spot for the vehicle, as described in further detail below with respect to FIGS. 3-9. The vehicle can operate in the capacity of a server or a client in a client-server network environment, or as a peer machine in a peer-to-peer (or distributed) network environment.

The system 200 includes one or more processing systems 202 (e.g., one or more processors or processing devices (e.g., microprocessor, central processing unit, or the like)), a memory 204 (e.g., read-only memory (ROM), flash memory, dynamic random access memory (DRAM) such as synchronous DRAM (SDRAM) or DRAM (RDRAM), flash memory, static random access memory (SRAM), etc.), and a data storage device 216 (e.g., a secondary memory unit in the form of a drive unit, which may include fixed or removable computer-readable storage medium), which communicate with each other via a bus 208. The one or more processing systems 202 may be configured to perform the operations, as described in further detail with respect to FIGS. 3-9.

The data processing system 200 may further include one or more sensor systems 214, one or more mechanical control systems 206 (e.g., motors, steering control, brake control, throttle control, etc.) and an airbag system 210. For one embodiment, one or more sensor systems 214 includes a set of sensors depicted in FIG. 1. The one or more processing systems 202 execute software instructions to perform different features and functionality (e.g., driving decisions) and provide a graphic user interface (GUI) 220 on a display device for a user of the vehicle. For one embodiment, GUI 220 is a touch-screen with an input and output functionality. For one embodiment, GUI 220 provides a playback through the vehicle's speaker system and display system of audio (and other) content to a user. The one or more processing systems 202 perform the different features and functionality for an operation of the vehicle based at least partially on receiving an input from the one or more sensor systems 214 that include one or more LiDAR sensors, one or more radar sensors, one or more ultrasonic sensors, one or more cameras, one or more global positioning system (GPS) sensors, additional sensors, or any combination thereof.

The data processing system 200 may further include a network interface device 222. The data processing system 200 also may include an input/output device 212 (e.g., a touch input, a voice activation device, a set of speakers, etc.). The data processing system 200 may further include a radio frequency (RF) transceiver 224 that provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/de-interleaving, spreading/dispreading, inverse fast Fourier transforming (IFFT)/fast Fourier transforming (FFT), cyclic prefix appending/removal, and other signal processing functions.

The data storage device 216 may include a machine-readable storage medium (or more specifically a computer-readable storage medium) on which is stored one or more sets of instructions embodying any one or more of the methodologies or functions described herein. A set of instructions to cause the data processing system 200 to perform one or more operations to detect an empty parking spot can be stored within the memory 204, within the one or more processing systems 202, within the data storage device 216, or any combination thereof that also constitute machine-readable storage media.

The term “machine-readable storage medium” should be taken to include a single medium or multiple media (e.g., a centralized or distributed database, and/or associated caches and servers) that stores the one or more sets of instructions. The terms “computer-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, and optical and magnetic media.

FIG. 3 is a flowchart of a method 300 to detect an empty parking spot for a vehicle according to one embodiment of the invention. At operation 301 signals reflected from one or more objects are received by at least one of a plurality of sensors coupled to a vehicle. For one embodiment, the vehicle is represented by one of vehicle 110, a vehicle 601 or a vehicle 801 as depicted in FIGS. 1, 6 and 8. For one embodiment, a plurality of sensors are represented by the sensors as depicted in FIGS. 1, 2, 6 and 8. At operation 302 one or more images are generated based on the received signals. For one embodiment, the received reflected laser light signals are processed to provide LiDAR sensor data. For one embodiment, the received reflected radar signals are processed to provide radar sensor data. For one embodiment, radar sensor data and LiDAR sensor data are combined, using a sensor data fusion technique known to one of ordinary skill in the art of data processing. For one embodiment, the one or more images are generated based on the combined radar sensor data and LiDAR sensor data.

At operation 303 one or more empty spaces as candidates for one or more available parking spots for the vehicle are determined based on at least one of the one or more images, radar sensor data and LiDAR sensor data. For one embodiment, a profile of an empty space is determined based on the images. For one embodiment, the profile includes a location of the empty space, a distance of the empty space to the vehicle, a size of the empty space, a shape of the empty space (e.g., a rectangular, an oval, a square, or any other geometrical shape), or any combination thereof. For one embodiment, a size of the vehicle is determined. For one embodiment, a location of the empty space is determined using one or more of LiDAR and radar sensor data. For one embodiment, a distance of the empty space to the vehicle is determined using one or more of LiDAR and radar sensor data. For one embodiment, a size of the empty space is determined based at least one of the one or more images, radar sensor data and LiDAR sensor data.

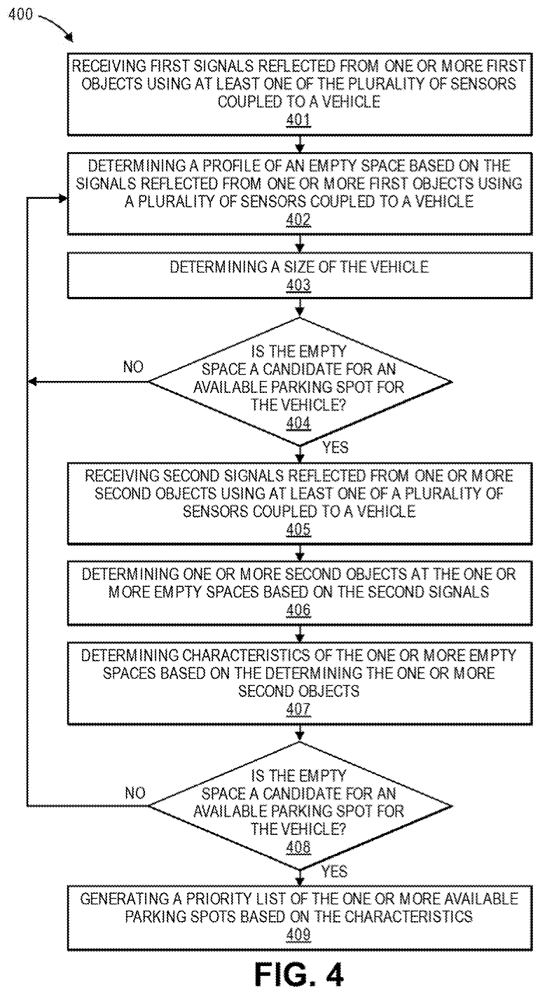

For one embodiment, a shape of the empty space is determined based at least one of the one or more images, radar sensor data and LiDAR sensor data. For one embodiment, the signals associated with the waves (e.g., laser, radar, or both laser and radar) reflected from the stationary objects (walls, neighboring vehicles, or other stationary objects) are received. One or more images are determined from the received reflected signals. For one embodiment, the size of the empty parking space is calculated from the one or more images. For one embodiment, the shape of the empty parking space is determined from the one or more images. For one embodiment, the size of the empty parking space is calculated using one or more formulas. For one embodiment, the size of the empty parking space is estimated using a machine learning technique. The empty space is an available parking spot for the vehicle is determined based on the profile of the empty space and the size of the vehicle, as described in further detail below with respect to FIGS. 4, 6 and 7. For one embodiment, the size of the empty space is determined using a calibration technique. For one embodiment, the size of the empty space is determined using a learning technique. For one embodiment, the size of the empty space is determined using a supervised learning technique and an unsupervised learning technique. The calibration technique, supervised learning technique, and an unsupervised learning technique are known to one of ordinary skill in the art of data processing.

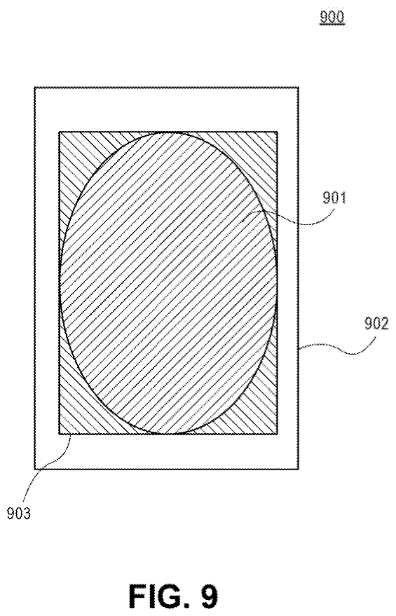

For one embodiment, a size (e.g., length, width, height) of the empty parking spot is estimated using the image. An actual size of the empty parking spot is measured and stored in a memory of the vehicle. The estimated size is compared to the actual size of the empty parking spot. If the estimated size does not match the actual size of the empty parking spot, an adjustment to the estimated size is determined based on a difference between the estimated size and the actual size, as described in further detail with respect to FIG. 9.

For one embodiment, the processor of the vehicle is configured to “learn” from the adjustment to increase accuracy of future estimates of the size of the empty parking spot. For one embodiment, the processor of the vehicle is configured to store the adjustment in a memory, and to share the learnings of the estimates of the empty parking spot with other cars directly via a virtual-to-virtual (V2V) communication link or indirectly, through an intermediary, e.g., a cloud server. For one embodiment, the processor of the vehicle is configured to use the learnings of the estimates of the empty parking spot to update a map application that is available to other vehicle drivers.

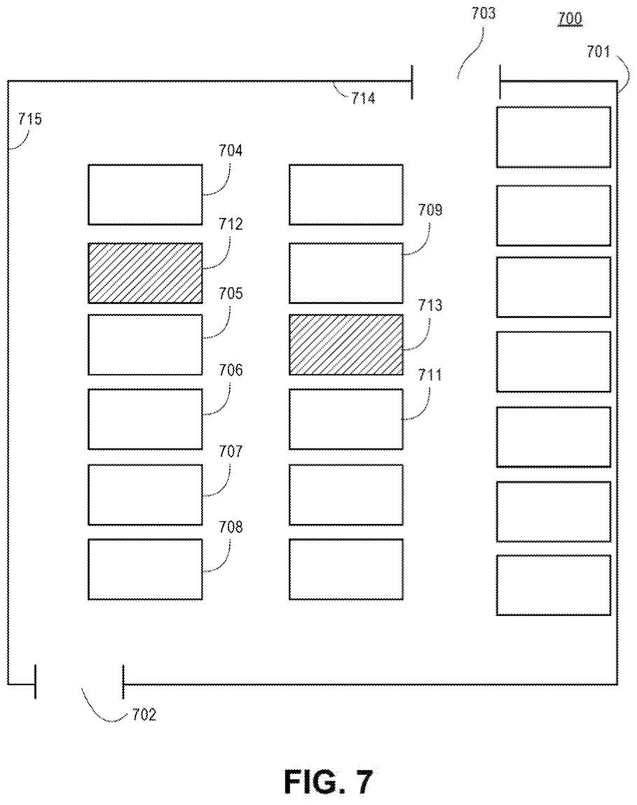

At operation 304 a map including the locations of one or more available parking spots for the vehicle is generated, as described in further detail below with respect to FIG. 7. At operation 305 the map is displayed on a display device, such as the display device as described with respect to FIG. 2, or other display device. For one embodiment, the map including the locations of the one or more available parking spots for the vehicle is provided to an advanced driver-assistance system (ADAS), AD system, or both ADAS and AD to facilitate the assisted or autonomous driving of the vehicle. At operation 306, the map is shared to one or more other vehicles. For one embodiment, the vehicle leaving the garage area shares the map including the location of the empty parking spots to one or more other vehicles via a wireless communication link. For one embodiment, the map is shared to one or more other vehicles directly via a V2V communication link. For one embodiment, the map is shared to one or more other vehicles indirectly via an intermediary, e.g., a cloud server.

FIG. 4 is a flowchart of a method 400 to detect an empty parking spot for a vehicle according to one embodiment of the invention. At operation 401 first signals reflected from one or more first objects are received using at least one of a plurality of sensors coupled to a vehicle, as described above. For one embodiment, the first objects are stationary objects. At operation 402 a profile of an empty space is determined based on signals reflected from the one or more first objects. For one embodiment, the profile includes a location of the empty space, a distance of the empty space to the vehicle, a size of the empty space, a shape of the empty space, or any combination thereof. For one embodiment, a location of the empty space is determined using one or more of LiDAR and radar sensor data. For one embodiment, a distance of the empty space to the vehicle is determined using one or more of LiDAR and radar sensor data. For one embodiment, a size of the empty space is determined based at least one of the one or more images, radar sensor data and LiDAR sensor data.

For one embodiment, a shape of the empty space is determined based at least one of the one or more images, radar sensor data and LiDAR sensor data. For one embodiment, the signals associated with the waves (e.g., laser, radar, or both laser and radar) reflected from the stationary objects (walls, neighboring vehicles, or other stationary objects) are received. One or more images are determined from the received reflected signals. For one embodiment, the size of the empty parking space is calculated from the one or more images. For one embodiment, the shape of the empty parking space is determined from the one or more images. For one embodiment, the size of the empty parking space is calculated using one or more formulas. For one embodiment, the size of the empty parking space is estimated using a machine learning technique.

At operation 403, the size of the vehicle is determined. For one embodiment, the size of the vehicle includes a width of the vehicle, a length of the vehicle, a height of the vehicle, or any combination thereof. For one embodiment, the size of the vehicle is measured and stored in a memory. For one embodiment, the size of the vehicle is retrieved from the memory. At operation 404 it is determined if the empty space is a candidate for an available parking spot for the vehicle based on the profile of the empty space and the size of the vehicle. If it is determined based on the profile of the empty space and the size of the vehicle that the empty space is not a candidate for an available parking spot for the vehicle, method 400 returns to operation 402. If it is determined based on the profile of the empty space and the size of the vehicle that the empty space is a candidate for an available parking spot for the vehicle, method 400 continues at operation 405. For one embodiment, the size of the vehicle is compared to the size of the empty space. If the size of the empty space is not greater than the sum of the size of the vehicle and a predetermined safety margin, the empty space is not considered as a candidate for an available parking spot for the vehicle. If the size of the empty space is greater than the sum of the size of the vehicle and a predetermined safety margin, the empty space is considered as a candidate for the available parking spot for the vehicle. At operation 405 second signals are received using the at least one of the plurality of sensors coupled to the vehicle. At operation 406 one or more second objects are determined at the one or more empty spaces based on the second signals.

At operation 407 characteristics of the one or more empty spaces are determined based on the determining the one or more second objects. For one embodiment, the characteristics of the empty space include an indication of a restricted parking, an indication that the parking is not permitted, an indication of a special parking, or an indication that the empty space is not for parking. For one embodiment, the second objects are signs posted at the empty spot and the characteristics are determined by “reading” the images of the second objects that are generated using the data associated with the signals received from the at least one of the plurality of sensors coupled to the vehicle. For another embodiment, the characteristics of the one or more empty spaces associated with the one or more second objects are determined using an on board computer. For another embodiment, the characteristics of the one or more empty spaces associated with the one or more second objects are received from a remote server. For yet another embodiment, the characteristics of the one or more empty spaces associated with the one or more second objects are received from other cars. For one embodiment, the characteristics of the one or more empty spaces associated with the one or more second objects are learned and remembered by the vehicle. For one embodiment, the characteristics of the one or more empty spaces associated with the one or more second objects are shared with other vehicles via a V2V communication link or via a cloud server. At operation 408 it is determined whether the candidate empty space is an available parking spot for the vehicle based on the characteristic of the empty space.

If the empty space is not an available parking spot for the vehicle, method returns to operation 402. If the empty space is an available parking spot for the vehicle, method goes to operation 409 that involves generating a priority list of the one or more available parking spots based on the characteristics. For one embodiment, the priority list is displayed on a display device, such as the display device as described with respect to FIG. 2, or other display device. For one embodiment, the priority list is provided to an advanced driver-assistance system (ADAS), AD system, or both ADAS and AD to facilitate the assisted or autonomous driving of the vehicle.

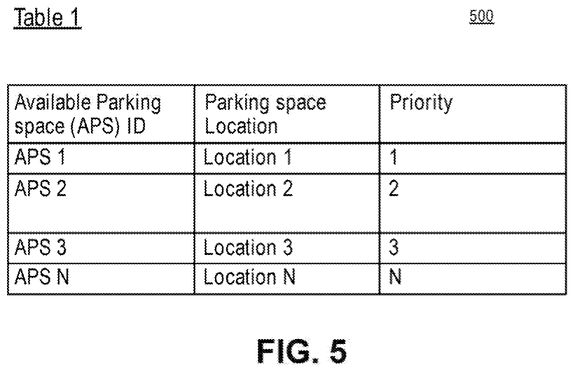

FIG. 5 shows an example of a data structure 500 that includes a priority list of one or more available parking spots according to one embodiment. As shown in FIG. 5, a Table 1 represents the data structure. For one embodiment, the data structure is created and stored in a storage device coupled to the vehicle. For one embodiment, the storage device is a memory of the vehicle, a database, a cloud, or a combination thereof. As shown in FIG. 5, Table 1 includes a column that identifies currently available parking spaces (APS) for a vehicle (e.g., APS 1, APS 2, APS 3 and APS N), a column that indicates a location of the APS (e.g., Location 1, Location 2, Location 3, Location N) and a priority of the APS (1, 2, 3, N) for a vehicle. For one embodiment, the priority of the APS is determined based on the preferences indicated by the user. For another embodiment, the priority of the APS is learned from the user's habit. For yet another embodiment, the priority of the APS is determined using one or more weighted parameters. For one embodiment, the one or more weighted parameters include, for example, closeness of the APS to the vehicle, a shade at the APS, price of the APS, a roof at the APS, or other parameters, or any combination thereof

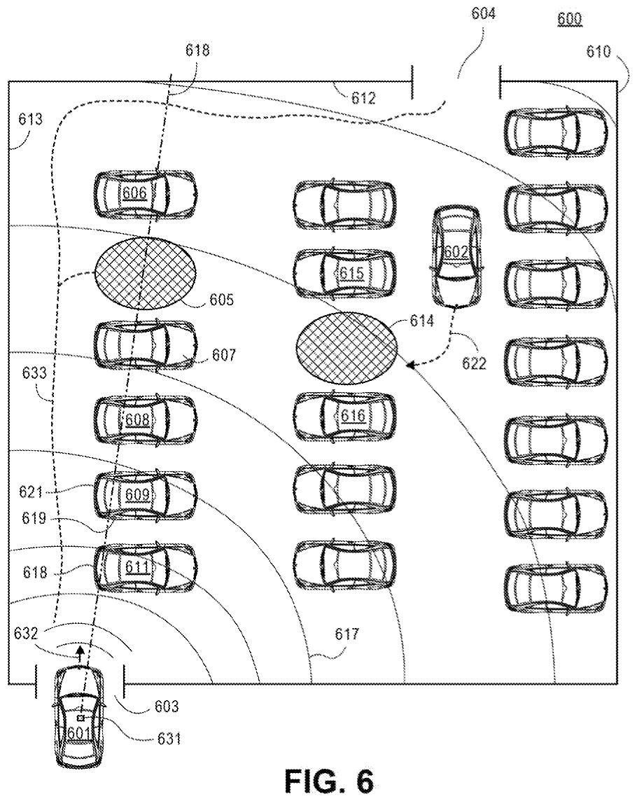

FIG. 6 is a view 600 of a parking garage 610 for vehicles according to one embodiment of the invention. As shown in FIG. 6, parking garage 610 has an entrance 603 and an exit 604, and a plurality of vehicles, such as vehicles 606, 607, 608, 609, 611, 615, 616 that are parked at their respective parking spots. As shown in FIG. 6, parking garage area 610 has an empty parking spot 605 and an empty parking spot 614 that are not occupied by other vehicles and are available for parking the vehicle 601. For one embodiment, a user of vehicle 601 entering 632 parking garage area 601 does not see empty parking spots 605 and 614. A sensor system 631 is on vehicle 601. For one embodiment, sensor system 631 represents one of the sensor systems described above with respect to FIGS. 1-5. Vehicle 601 represents one of the vehicles described above with respect to FIGS. 1-5.

As vehicle 601 moves in garage area 610 (e.g., along a path 633), a transmitter of the LiDAR sensor of sensor system 631 transmits a laser light 618 to illuminate portions of the objects, such as end portions parked vehicles 606, 607, 608, 609, 611, a portion of a wall 613 and a portion of a wall 612 that are within a current field of view (FOV) of the laser light 618. For one embodiment, the FOV of the laser light 618 corresponds to the viewing angle of the LiDAR sensor. For one embodiment, laser light 618 of the LiDAR sensor is used to detect the objects that are within a distance from vehicle 601 that is from about 0 meters (m) to 50 m within the viewing angle.

For one embodiment, a receiver of the LiDAR sensor of sensor system 631 receives the laser light signals that are reflected from portions of the objects, such as an edge portion 618 of parked vehicle 611, and an edge portion 621 and a side portion 619 of parked vehicle 609, and portions of other parked vehicles 606, 607, 608, a portion of a wall 613 and a portion of a wall 612 that are within a current field of view (FOV) of the laser beam 618.

As shown in FIG. 6, a transmitter of the radar sensor of sensor system 631 transmits radar waves 617 to reach objects that are partially reachable by the LiDAR sensor, such as parked vehicles 606, 607, 608, 609, 611, wall 613 and wall 612, and to reach objects that are not reachable by the LiDAR sensor, such as parked vehicles 615 and 616, a moving vehicle 622, and other walls of the parking garage 610. The relatively weak absorption of radar waves 617 by the medium through which the radar waves pass enables the radar sensor of sensor system 631 to detect the objects at longer ranges than the LiDAR sensor.

For one embodiment, a receiver of the radar sensor of sensor system 631 receives the radar wave signals that are reflected from the objects, such as parked vehicles 606, 607, 608, 609, 611, wall 613 and wall 612, parked vehicles 615 and 616, a moving vehicle 622, and other walls of the parking garage 610. For one embodiment, the viewing angle of the radar sensor is greater than the viewing angle of the LiDAR sensor. For one embodiment, the radar waves 617 of the radar sensor are used to detect the objects at a distance from about 1 centimeter (cm) to about 300 meters. For one embodiment, the radar sensor is a high range radar sensor to detect the objects at a distance from about 50 meters to about 100 meters. For one embodiment, as the resolution of the LiDAR sensor is greater than the resolution of the radar sensor, the LiDAR sensor is used to detect the features of the objects that are not detectable by the radar sensor.

For one embodiment, the speed and direction of movement of the one or more other vehicles, such as a moving vehicle 602 are detected in the garage area using the radar and LiDAR sensors coupled to the vehicle 601. For one embodiment, each of probabilities of occupying the empty parking spots (e.g., empty parking spots 605 and 614) by the vehicle 601 are estimated based on the speed and direction of movement of vehicle 601 relative to the one or more other vehicles. For example, the probability estimate of occupying the empty parking spot 605 for vehicle 601 is determined to be 90% and the probability estimate of occupying the empty parking spot 614 for vehicle 601 is determined to be 30% based on the determination that the vehicle 602 moves towards and is closer to empty parking spot 614 than vehicle 601. For one embodiment, the probability estimate of occupying an empty parking spot for the vehicle is calculated using the data associated with the speed and direction of movement of other vehicles.

For one embodiment, the probability estimates of occupying the empty parking spots are provided to the user of the vehicle via a GUI on the display device. For one embodiment, the probability estimates of occupying the empty parking spots are provided to an advanced driver-assistance system (ADAS), AD system, or both ADAS and AD to facilitate the assisted or autonomous driving of the vehicle.

FIG. 7 is a view 700 of a map 701 including locations of available parking spots according to one embodiment of the invention. As shown in FIG. 7, map 701 shows a location of entrance 702 that represents entrance 603 and a location of an exit 703 that represents exit 604, and a plurality of occupied locations, such as occupied locations 704, 705, 706, 707, 708, 709, 711 that represent the locations occupied by vehicles 606, 607, 608, 609, 611, 615, 616 respectively. As shown in FIG. 7, map 701 shows a plurality of empty parking spot locations, such as an empty parking spot location 712 that represents empty parking spot 605 and an empty parking spot location 713 that represents empty parking spot 614. For one embodiment, the location indicated by the map is identified by at least one of the 3D coordinates (x, y, z) relative to a reference location, e.g., an entrance, or other reference. For another embodiment, the location indicated by the map is identified by a distance from the vehicle. For one embodiment, the map 701 includes the probability estimates of occupying the empty parking spot for the vehicle, as described above.

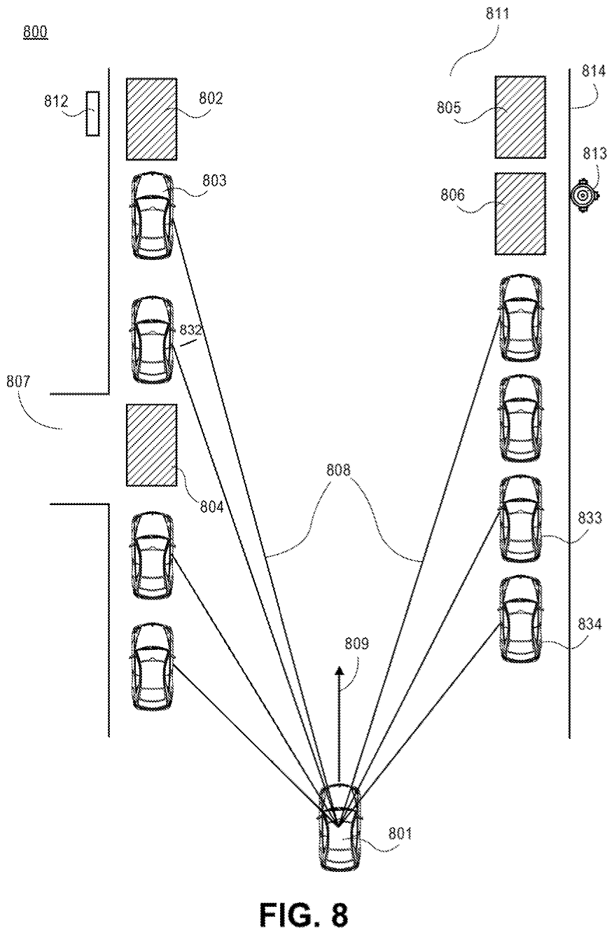

FIG. 8 is a view 800 of a street parking 811 according to one embodiment of the invention. As shown in FIG. 8, street parking 811 includes a plurality of spaces that are occupied by vehicles, e.g., vehicles 803, 832, 833 and 834 and a plurality of spaces, such as spaces 802, 804, 805, 806 are not occupied by a vehicle (empty spaces). For one embodiment, a user of vehicle 801 entering 809 street parking 811 does not see empty spaces 802, 804, 805, 806. A sensor system is on vehicle 801. For one embodiment, the sensor system of vehicle 801 represents one of the sensor systems described above with respect to FIGS. 1-7. Vehicle 801 represents one of the vehicles described above with respect to FIGS. 1-7. As vehicle 801 moves 809 towards street parking 811, one or more transmitters of the sensor system of the vehicle 801 transmit laser light signals and radar signals to target objects, as described above. One or more receivers of the sensor system of the vehicle 801 receive the signals 808 that are reflected from the objects that occupy the parking spaces of the street parking 811.

The profiles of the empty spaces 802, 804, 805, 806 are determined based on the reflected signals, as described above. If it is determined that the empty spaces 802, 804, 805, 806 are candidates for an available parking for vehicle 801, one or more transmitters of the sensor system of the vehicle 801 transmit laser light signals and radar signals to determine characteristics of the empty parking spaces based on the signals that are reflected from objects that are adjacent to the empty parking spaces 802, 804, 805 and 806. For one embodiment, the objects that are adjacent to the empty spaces are identified based on the reflected signals. For example, an object 812 adjacent to empty space 802 is identified as a restricted parking sign, an object 813 adjacent to empty space 806 is identified as a fire hydrant, an object 807 is identified as a driveway, and an object 814 is identified as a portion of the sidewalk. For one embodiment, the characteristics of the empty parking spaces are determined based on the identified objects.

For one embodiment, the characteristic of the empty space includes an indication of a restricted parking, an indication that the parking is not permitted, an indication of a special parking, or an indication that the empty space is not for parking. For example, it is determined that empty space 804 is for parking, as object 807 is identified as a driveway, empty space is for restricted parking, as object 812 is identified as a restricted parking sign. For example, parking space 805 may be identified as having a highest parking priority for vehicle 801, parking space 802 may be identified as having an intermediate parking priority for vehicle 801, and parking space 806 may be identified as having a lowest parking priority for the vehicle. For one embodiment, the objects 807, 812, and 806 are recognized from the images generated using the signals reflected from these objects. For one embodiment, one or more optical character recognition (OCR) techniques can be used to read from the images of the signs posted at the available parking spaces. For one embodiment, 3D Objects can be detected using one or more Radar(s) or Lidar(s). For one embodiment, sign Recognition (e.g., handicapped parking, or other sign special parking) is done using an image recognition technique using one or more cameras.

FIG. 9 shows an example of an image 900 that is generated based on the combined radar sensor data and LiDAR sensor data according to one embodiment. For one embodiment, the combined radar sensor data and LiDAR sensor data are derived from the received signals that are reflected from the objects that are located adjacent to an empty parking spot. For one embodiment, one or more images of the empty parking spot are generated using the combined radar sensor data and LiDAR sensor data. For one embodiment, the images show the distribution of the intensity of the reflected electromagnetic waves in two dimensions (x, y). For another embodiment, the images show the distribution of the intensity of the reflected electromagnetic waves in three dimensions (x, y, z). For one embodiment, one or more images of the empty parking spot are calculated from the combined radar sensor data and LiDAR sensor data using a formula. For one embodiment, one or more images of the empty parking spot are generated from the combined radar sensor data and LiDAR sensor data using a learning algorithm. For one embodiment, the dimensions (e.g., length, width and depth) of the empty parking spot are created using a point cloud generated by one or more LIDARs or RADARs, connecting the outermost array of points and then approximating (error reduced with field learnings) the cuboidal space. The algorithms and models improve and become more accurate with learnings.

As shown in FIG. 9, the image 900 includes a portion 901 and a portion 902. For one embodiment, the intensity of the reflected electromagnetic wave signals in portion 902 is greater than a first predetermined threshold. For one embodiment, the intensity of the reflected electromagnetic wave signals in portion 901 is smaller than a second predetermined threshold. For one embodiment, the first predetermined threshold is associated with an object. For one embodiment, the second predetermined threshold is associated with an empty space. For one embodiment, the intensity of the reflected electromagnetic wave signals in portion 902 is substantially higher than the intensity of the reflected electromagnetic wave signals in portion 901. Portion 902 represents the objects that reflect the electromagnetic wave signals. Portion 901 represents an empty space, as the empty space does not reflect the electromagnetic wave signals. For one embodiment, portion 901 represents an empty parking spot (e.g., one of the empty parking spots, as depicted in FIGS. 6 and 7). For one embodiment, portion 902 represents objects that surround the empty parking spot (e.g. portions of parked vehicles, as depicted in FIGS. 6 and 7). For one embodiment, image 900 is a thermal image. For one embodiment, image 900 is generated using at least one of image processing techniques and learning techniques. Image processing techniques and learning techniques are known to one of ordinary skill in the art of image processing.

For one embodiment, the size (e.g., length, width, height) of the empty parking spot is estimated using the image 901. For example, if estimated dimensions (length and width) 903 of the empty parking spot determined based on image 901 are 2m by 3m, and the actual dimensions (length and width) 902 of the empty parking spot 605 are 3m by 4m, an adjustment offset is lm by lm. For one embodiment, an adjustment offset is determined based on a reference, for example a center of image 901, or any other non-movable reference. For one embodiment, the actual dimensions 902 are measured and stored in a memory of the vehicle. For one embodiment, the processor of the vehicle is configured to “learn” from the adjustment to increase accuracy of future estimates of the size of the empty parking spot. For one embodiment, the processor of the vehicle is configured to store the adjustment in a memory, and to share the learnings of the estimates of the empty parking spot with other cars directly via a virtual-to-virtual (V2V) communication link or indirectly, through an intermediary, e.g., a cloud server. For one embodiment, the processor of the vehicle is configured to use the learnings of the estimates of the empty parking spot to update a map application that is available to other vehicle drivers.

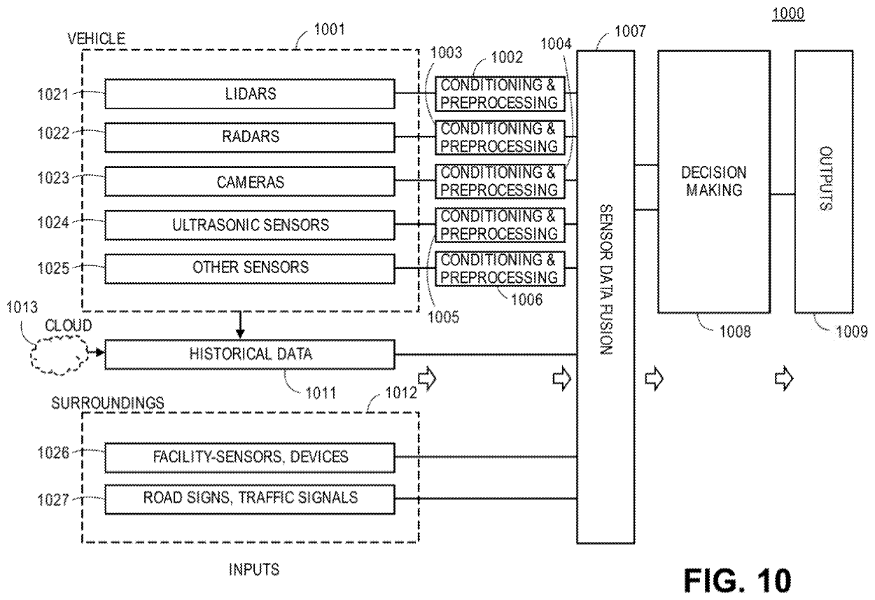

FIG. 10 is an example of a driving system 1000 to perform one or more methods described herein. Driving system 1000 includes a vehicle 1001 that includes one or more LiDARs 1021, one or more radars 1022, one or more cameras 1023, one or more ultrasonic sensors 1024 and one or more other sensors 1025 that are configured to receive corresponding electromagnetic waves signals that are reflected from one or more objects, as described above. For one embodiment, vehicle 1001 represents one of the vehicles described above. Driving system 1000 includes a historical data processing unit 1011 including one or more processors coupled to a memory that are configured to receive the sensor data from one or more LiDARs 1021, one or more radars 1022, one or more cameras 1023, one or more ultrasonic sensors 1024 and one or more other sensors 1025 and store the sensor data in a cloud 1013 to access the stored data over the Internet.

Driving system 1000 includes a surrounding data processing unit 1012 that includes one or more processors coupled to a memory that are coupled to one or more facility sensors and other devices 1026 to receive facility information data and one or more processing units 1027 to receive road sign information and traffic information data, as described above. A sensor data fusion unit 1007 includes one or more processors coupled to a memory that are configured to receive and fuse the conditioned and preprocessed sensor data output from conditioning and preprocessing units 1002, 1003, 1004, 1005 and 1006, the historical data output from historical data processing unit 1011 and the surrounding information data output from surrounding data processing unit 1012 and to output the fused sensor data, historical sensor data, current sensor data, and surrounding information data to a decision making unit 1008, as described above. Decision making unit 1008 includes one or more processors and a memory coupled to the processors to execute one or more algorithms to determine an empty parking spot, as described above. Decision making unit 1008 is coupled to one or more outputs 1009 to output information regarding an empty parking spot to a user of the vehicle, as described above. For one embodiment, one or more outputs 1009 represent GUI 220. For one embodiment, one or more outputs 1009 represent an output portion of input/output device 212.

It is apparent from this description that embodiments and aspects of the present invention may be embodied, at least in part, in software. That is, the techniques and methods may be carried out in a data processing system or set of data processing systems in response to one or more processors executing a sequence of instructions stored in a storage medium, such as a non-transitory machine readable storage media, such as volatile DRAM or nonvolatile flash memory. In various embodiments, hardwired circuitry may be used in combination with software instructions to implement the embodiments described herein. Thus the techniques and methods are not limited to any specific combination of hardware circuitry and software, or to any particular source for the instructions executed by the one or more data processing systems.

In the foregoing specification, specific exemplary embodiments have been described. It will be evident that various modifications may be made to those embodiments without departing from the broader spirit and scope set forth in the following claims. The specification and drawings are, accordingly, to be regarded in an illustrative sense rather than a restrictive sense.

What is claimed is:

1. A data processing system to detect an empty parking spot for a vehicle comprising:
a plurality of sensors;
a processor coupled to the plurality of sensors, wherein the processor is configured to receive first signals reflected from one or more first objects using at least one of a plurality of sensors coupled to a vehicle; to generate one or more images of the one or more first objects based on the first signals; to determine one or more empty spaces as candidates for one or more available parking spots for the vehicle based on the one or more images; and to generate a map including the one or more available parking spots for the vehicle.

2. The data processing system of claim 1, wherein the processor is further configured to determine a profile of an empty space based on the images, wherein the profile comprises a location of the empty space, a distance of the empty space to the vehicle, a size of the empty space, a shape of the empty space, or any combination thereof; to determine a size of the vehicle; and to determine if the empty space is a candidate for an available parking spot for the vehicle based on the profile of the empty space and the size of the vehicle.

3. The data processing system of claim 1, wherein the processor is further configured to receive second signals using the at least one of the plurality of sensors coupled to the vehicle; to determine one or more second objects at the one or more empty spaces based on the second signals; to determine characteristics of the one or more empty spaces based on the determining the one or more second objects; and to generate a priority list of the one or more available parking spots based on the characteristics.

4. The data processing system of claim 1, wherein the processor is further configured to send the map to a display device, an advanced driver-assistance system, an autonomous driving system, or any combination thereof.

5. The data processing system of claim 1, wherein the sensors include one or more LiDAR sensors and one or more radar sensors.

6. The data processing system of claim 1, wherein the processor is further configured to share the map to one or more other vehicles via a virtual to virtual link, a cloud, or any combination thereof.

7. The data processing system of claim 1, wherein the processor is further configured to estimate a size of an empty space using a calibration technique.

8. A machine implemented method to detect a parking spot for a vehicle comprising:
receiving first signals reflected from one or more first objects using at least one of a plurality of sensors coupled to a vehicle;
generating one or more images of the one or more first objects based on the first signals;
determining one or more empty spaces as candidates for one or more available parking spots for the vehicle based on the one or more images; and
generating a map including the one or more available parking spots for the vehicle.

9. The method of claim 8, further comprising:
determining a profile of an empty space based on the images, wherein the profile comprises a location of the empty space, a distance of the empty space to the vehicle, a size of the empty space, a shape of the empty space, or any combination thereof;
determining a size of the vehicle; and
determining if the empty space is a candidate for an available parking spot for the vehicle based on the profile of the empty space and the size of the vehicle.

10. The method of claim 8, further comprising:
receiving second signals using the at least one of the plurality of sensors coupled to the vehicle;
determining one or more second objects at the one or more empty spaces based on the second signals;
determining characteristics of the one or more empty spaces based on the determining the one or more second objects; and
generating a priority list of the one or more available parking spots based on the characteristics.

11. The method of claim 8, further comprising:
sending the map to a display device, an advanced driver-assistance system, an autonomous driving system, or any combination thereof.

12. The method of claim 8, wherein the sensors include one or more LiDAR sensors and one or more radar sensors.

13. The method of claim 8, further comprising:
sharing the map to one or more other vehicles via a virtual to virtual link, a cloud, or any combination thereof.

14. The method of claim 8, further comprising estimating a size of an empty space using a calibration technique.

15. A non-transitory machine-readable medium storing executable computer program instructions to cause a data processing system to perform operations comprising:
receiving first signals reflected from one or more first objects using at least one of a plurality of sensors coupled to a vehicle;
generating one or more images of the one or more first objects based on the first signals;
determining one or more empty spaces as candidates for one or more available parking spots for the vehicle based on the one or more images; and
generating a map including the one or more available parking spots for the vehicle.

16. The non-transitory machine-readable medium of claim 15, further comprising instructions that cause the one or more data processing systems to perform operations comprising:
determining a profile of an empty space based on the images, wherein the profile comprises a location of the empty space, a distance of the empty space to the vehicle, a size of the empty space, a shape of the empty space, or any combination thereof;
determining a size of the vehicle; and
determining if the empty space is a candidate for an available parking spot for the vehicle based on the profile of the empty space and the size of the vehicle.

17. The non-transitory machine-readable medium of claim 15, further comprising instructions that cause the one or more data processing systems to perform operations comprising:
receiving second signals using the at least one of the plurality of sensors coupled to the vehicle;
determining one or more second objects at the one or more empty spaces based on the second signals;
determining characteristics of the one or more empty spaces based on the determining the one or more second objects; and
generating a priority list of the one or more available parking spots based on the characteristics.

18. The non-transitory machine-readable medium of claim 15, further comprising instructions that cause the one or more data processing systems to perform operations comprising:
sending the map to a display device, an advanced driver-assistance system, an autonomous driving system, or any combination thereof.

19. The non-transitory machine-readable medium of claim 15, wherein the sensors include one or more LiDAR sensors and one or more radar sensors.

20. The non-transitory machine-readable medium of claim 15, further comprising instructions that cause the one or more data processing systems to perform operations comprising:
sharing the map to one or more other vehicles via a virtual to virtual link, a cloud, or any combination thereof.

21. The non-transitory machine-readable medium of claim 15, further comprising instructions that cause the one or more data processing systems to perform operations comprising:
estimating a size of an empty space using a calibration technique.
